(19) United States
(12) Patent Application Publication
(10) Pub. No.: US 2008/0064322 A1
(43) Pub. Date: Mar. 13, 2008

(54) Fire damper assembly

(76) Inventor: Muhammad I. Rammal, Standish, MI (US)

Correspondence Address: McCulloch PLC, 1st Floor, 5291 Colony Drive North, Saginaw, MI, 48638, US

(21) Appl. No.: 11/518,835

(22) Filed: Sep. 11, 2006

(51) Int. Cl. A62C 2/06; A62C 39/00; A62C 2/12

(52) U.S. Cl. 454/369; 454/257; 454/357

(57) ABSTRACT

A fire damper assembly has a damper mounted in an air duct for movements between air passing position in which the damper enables air to flow through the duct and another position in which the damper blocks the passage of air through the duct. A strut composed of joined but separable components normally underlies the damper and supports the latter in the air passing position. The strut may be moved from its damper engaging position to a damper-free position while the separable components remain joined. One end of the strut is pivoted to the frame for swinging movements between damper engaging and damper-free positions and may have its opposite end manually detached from the frame, thereby enabling the damper to move to its air-blocking position. Both the damper and the strut may be returned to their respective positions in which the damper is supported in the air-passing position, and the strut may be moved between its damper-engaging and damper-disengaged positions manually and without requiring the strut to be visible.

This disclosure relates to a fire damper assembly of the kind installed in an air duct for movement of a damper from a retracted, air-passing position to an extended, air-blocking position in response to a predetermined rise in ambient temperature.

### BACKGROUND OF THE APPARATUS

It is common practice to provide in a commercial building air ducts through which air may flow from a furnace, boiler, air conditioner, and the like to one or more areas in the building. It also is common practice to install in each air duct one or more dampers which normally are in an open or retracted position enabling air flow through the duct. However, when ambient temperature rises as a result of a fire or over-heated condition a fusible link assembly responds to a predetermined increase in ambient temperature and enables the associated damper to move from its air-passing position to its air-blocking position, thereby minimizing the supply of air to the affected area.

Most state and municipal codes require the fire dampers to be tested periodically to ensure their operability. Many fire dampers are of the kind wherein the damper is supported in its air-passing position by a collapsible strut composed of separable fusible links. Testing of such a damper assembly requires removal of the fusible strut from its damper-supporting position to a position free of the damper, thereby enabling the latter to move to its air-blocking position. Following the test, the damper is returned manually to its retracted, air-passing position and the fusible strut is manually returned to its damper-engaging position.

The dampers are installed in strategic positions and each duct within which a damper is installed has an access or inspection opening by means of which a technician may gain access to the damper for cycling it between its air passing and air-blocking positions. However, these openings usually are fairly small in area so as to avoid the creation of air leaks. As a consequence, access to the fusible strut and damper is quite limited, thereby making it difficult for the damper to be tested and reset properly. In addition, the access to the damper assembly often is obstructed by the presence of pipes, ducts, cables, and the like which are adjacent or within the air duct. Consequently, visual inspection and manual actuation of the damper assembly are hampered.

A principal objective of the apparatus disclosed herein is to provide a damper and collapsible support assembly which is easily operable for test purposes and manually resettable even though visual and manual access to the damper assembly is less than ideal.

### SUMMARY OF THE DISCLOSURE

A fire damper assembly as disclosed herein comprises a frame which spans an air duct and mounts a damper which is movable from a normal, retracted position in which the flow of air through the duct is unimpeded to an extended position in response to an increase in ambient temperature so as to obstruct or block the flow of air through the duct. The damper may be gravity or spring biased from its retracted position to its extended position and maintained in its retracted position by a collapsible strut including one or more fusible links which are joined by a eutectic substance which liquefies at a predetermined temperature.

The strut is connected at its opposite ends to the frame so as to underlie and support the damper. At least one end of the strut is removably connected to the frame so as easily to be disconnected therefrom. The opposite end of the strut is pivotable so that, when the one end of the strut is disconnected from the frame, the strut will swing by gravity to a position free of the damper, thereby enabling the latter to move from its air-passing to its air-blocking position.

Following testing of the damper assembly the damper may be returned manually to its air-passing position and the strut returned manually to its damper-supporting position and reconnected to the frame. The connection between the strut and the frame is one that can be manipulated manually and without having to be seen by the operating technician, thereby greatly facilitating testing of the damper assembly.

### THE DRAWINGS

Several embodiments of the invention are illustrated in the accompanying drawings wherein:

FIG. 1 is an isometric view of a damper-accommodating frame within which is a damper supported in a retracted, air-passing position by a collapsible strut;

FIG. 2 is a view similar to FIG. 1 but illustrating the strut in damper-free position and the damper in extended, air-blocking position;

FIG. 3 is a vertical sectional view illustrating the damper supported by the collapsible strut in its retracted, air-passing position;

FIG. 4 is a view similar to FIG. 3, but illustrating the damper in its extended, air-blocking position;

FIG. 5 is an exploded, isometric view of the collapsible strut and its connecting means for connecting and disconnecting the strut from the frame;

FIGS. 6 and 7 are views similar to FIGS. 3 and 4, respectively, illustrating a different collapsible strut embodiment;

FIG. 8 is an isometric view illustrating the strut of FIGS. 6 and 7 removably connected to the damper-supporting frame;

FIG. 9 is a view similar to FIG. 1, but illustrating another modified embodiment of the collapsible strut;

FIG. 10 is an isometric view illustrating in greater detail the strut of FIG. 9;

FIGS. 11 and 12 are views similar to FIGS. 3 and 4, respectively, but illustrating the modified strut in its damper-supporting and its damper-free positions, respectively;

FIG. 13 is a view similar to FIG. 10 but illustrating the components of the strut in collapsed condition;

FIG. 14 is a view similar to FIG. 1, but omitting the damper support and illustrating adjustable connections for attaching the strut to the damper support.

### THE PREFERRED EMBODIMENTS

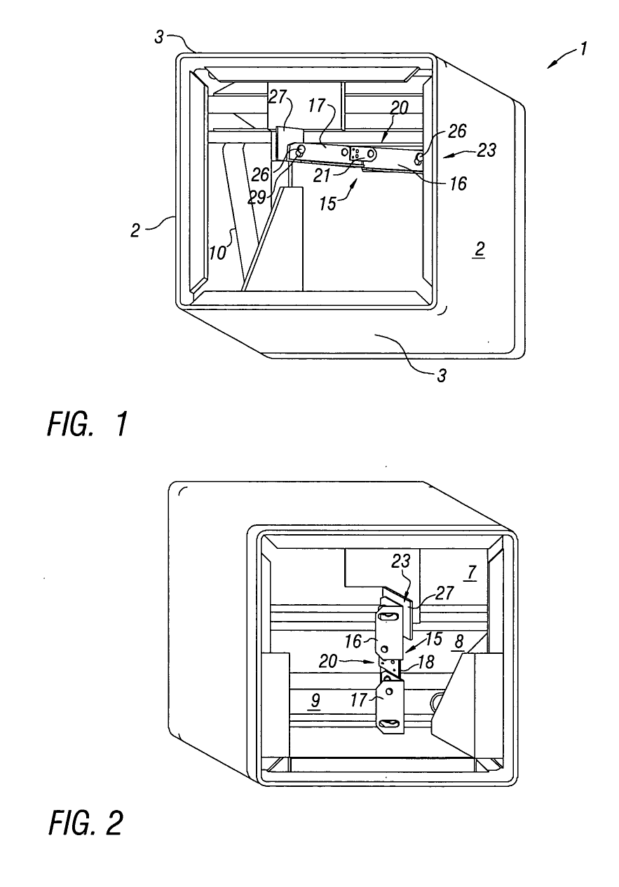

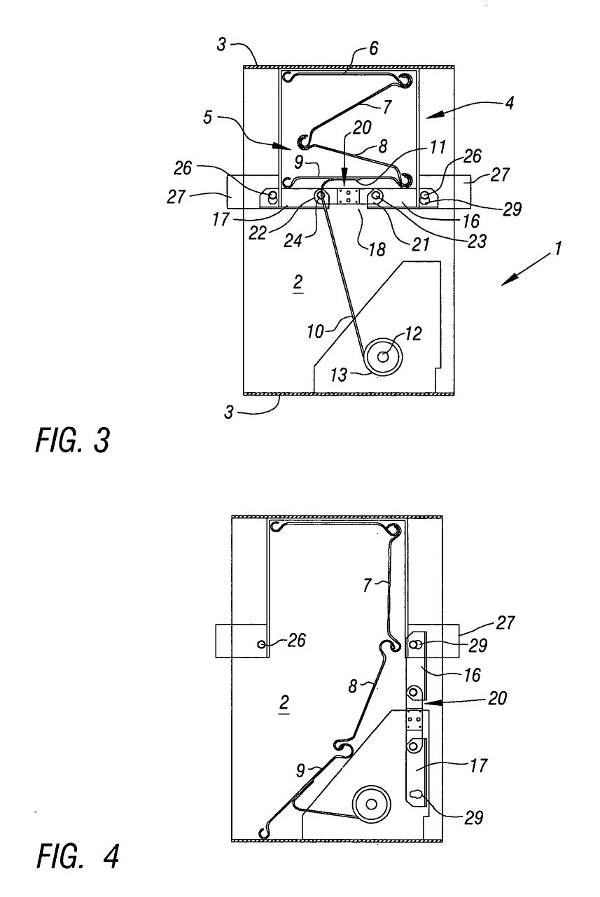

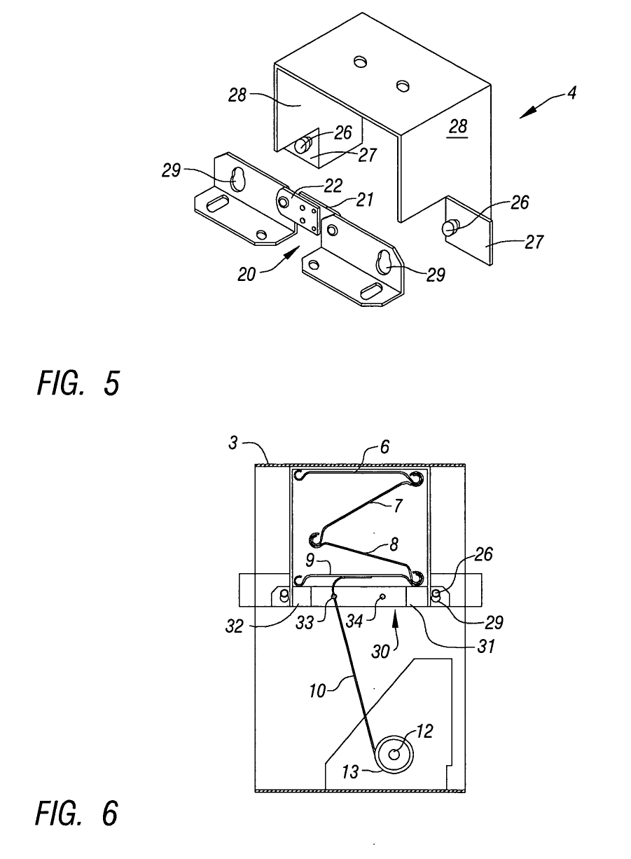

Apparatus constructed in accordance with the embodiment shown in FIGS. 1-5 includes a frame 1 which may comprise an air duct or a separate frame accommodated within and fixed to such duct. In either event, the frame has opposed side walls 2 joined by top and bottom walls 3. Within the frame is an open sided, open bottom housing 4 within which is mounted an extendible and retractable damper 5 of known construction. The damper has a plurality of pivoted leaves including an anchor leaf 6 fixed to the top wall of the housing 4 and pivotally coupled to leaves 7, 8, and 9 which, in the retracted position shown in FIGS. 1 and 3 occupy a folded condition which enables air to move through the duct past the damper. A coilable spring blade 10 is secured at one end 11 to the damper leaf 9 and has its other end secured to a spindle 12 mounted within a housing 13 for rotation. The spindle is connected to a torsion spring (not shown) which urges the spindle to rotate in such direction as to cause the blade 10 to be wound about the spindle within the housing.

The spring blade 10 constantly biases the damper to move from its-air-passing, retracted position shown in FIGS. 1 and 3 to an extended, air-blocking position shown in FIGS. 2 and 4. The damper could be gravity biased, if desired, but for assured operability the damper preferably is spring biased to its extended position.

The apparatus thus far described is conventional and forms no part of the invention apart from its cooperative relationship with the apparatus subsequently described herein.

The apparatus includes a collapsible strut 15 which, in one position, underlies and engages the lower leaf 9 of the damper and maintains the damper in its retracted position until such time as it is desired to enable the damper to move from its retracted position to its extended position. The strut comprises a plurality of separate components 16 and 17 which are aligned with one another, but spaced by a gap 18. The gap is spanned by a thermally sensitive, fusible linkage 20 having two links 21 and 22 which overlap one another. The link 21 is secured to the component 16 by a rivet 23 and the link 22 is secured to the component 17 by a rivet 24. Interposed between the overlapping ends of the links 21 and 22 is a known eutectic material (not shown) which, under normal ambient temperature conditions, is solid and secures the two links to one another. However, in response to an increase in ambient temperature to a predetermined level the eutectic material will liquefy and enable the two links 21 and 22 to separate from one another, thereby enabling the strut 15 to collapse. The construction and operation of the links 21 and 22 and the eutectic material are well known and conventional. Such links and material are commercially available from Globe Technologies Corporation, Standish, Mich.

Connecting means 25 is provided at each end of the strut 15 for removably connecting the strut to the frame via the housing 4 and in a position to underlie and support the damper. Each connecting means comprises a headed pin 26 secured to and projecting from a tab 27 extending from side walls 28 of the housing 4. Each of the strut-forming limbs 16 and 17 has a bayonet slot 29 for the accommodation of one of the pins 26. The strut 15 can be removed from both of the pins 26 so as to enable the strut to be replaced by another. However, if the strut is to be removed from only one of the pins, the other pin forms a pivot about the axis of which the strut may swing from its damper engaging and supporting position to a vertical position, as shown in FIGS. 2 and 4 in which the strut is disengaged from the damper. Disengagement of the strut from the damper enables the latter to move from its upper or retracted position to its extended position in which it blocks the flow of air past the damper.

The disconnection of one of the ends of the strut from one of the connecting pins 26 may be accomplished manually by a technician's simply raising one end of the strut slightly and pulling such end in a direction to enable the adjacent pin to pass through the bayonet slot. No bending or threading or other adjustment of any part of the strut connecting means is required.

To restore the damper to its retracted position the extended damper leaves may be moved manually upwardly and held in such position while the strut is rocked about the axis of the one pin 26 until the bayonet slot at the opposite end of the strut may be aligned and slipped over the other pin 26. Again, this operation may be performed manually without having to view the component parts of the assembly and without having to bend, thread, or otherwise adjust the parts of the assembly. The simplicity of the connection and disconnection of the supporting strut to the damper mounting frame is such that testing the operability of the damper is neither awkward nor burdensome.

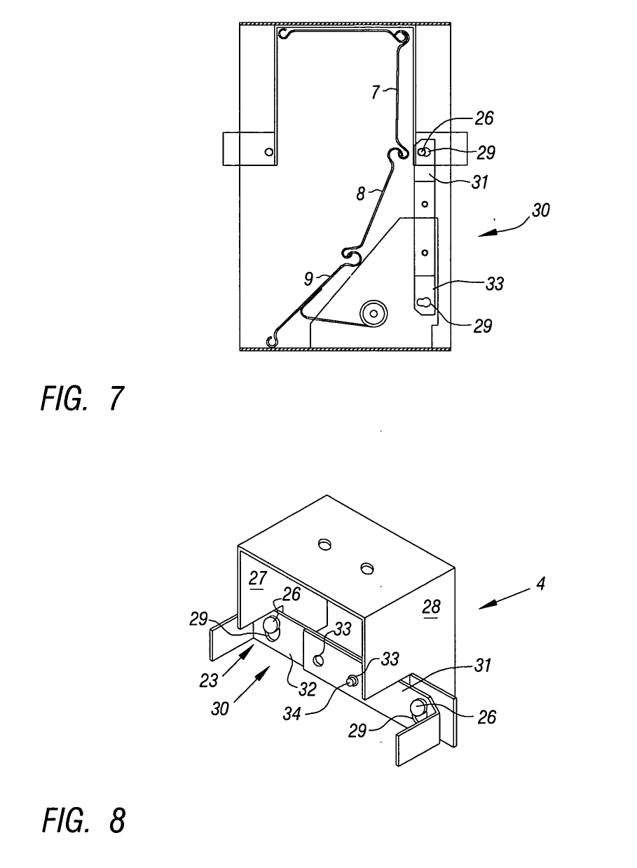

The embodiment shown in FIGS. 6-8 corresponds to that described earlier with the exception that the damper engageable support strut 30 comprises two links 31 and 32 having corresponding ends which overlap one another. The overlapping portions of the strut have guide openings 33 through which bullet-nosed retainers 34 removably extend. The retainers maintain the link components in alignment until such time as the eutectic material (not shown) that is interposed between the overlapping portion of the links liquefies, whereupon the force applied on the strut by the overlying damper effects separation of the links.

The operation of the embodiment shown in FIGS. 6-8 corresponds to that illustrated in FIGS. 1-5.

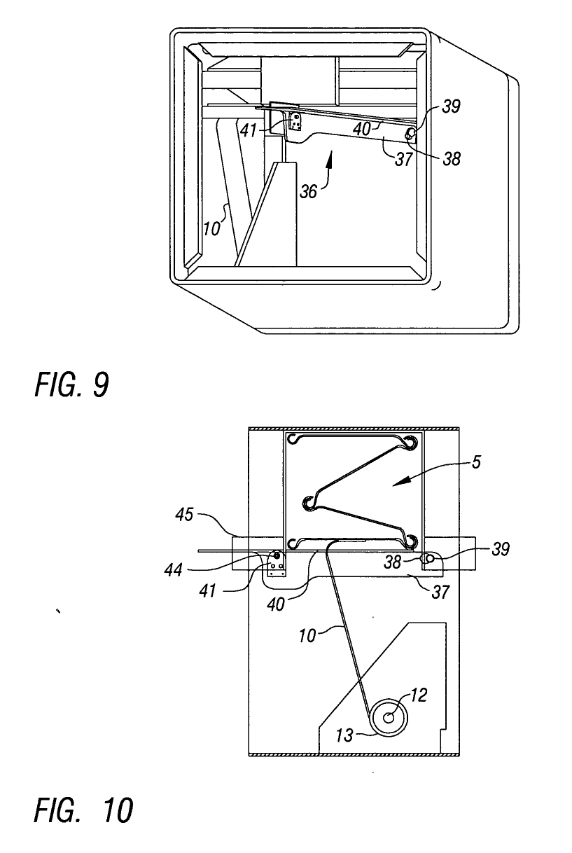

The embodiment shown in FIGS. 9-12 corresponds to the previously described two embodiments except for the damper engaging strut 36. The strut 36 comprises a lever or support arm 37 having at one end a bayonet slot 38 which rockably accommodates a pin 39, thereby mounting the strut 36 for swinging movements about the axis of the pin 39. The lever 37 includes a right angular flange 40 which may underlie and engage the lower leaf 9 of the damper when the latter is in its retracted, air passing position. That end of the lever opposite the connecting bayonet slot and pin is separably secured by a eutectic substance (not shown) to a link 41 having aligning openings and projections 42 similar to those shown in FIGS. 1-5. The link also has adjacent its free end an opening 43 which accommodates a retaining stud or projection 44 which is fixed to a tab 45 forming part of the housing 4 and extends through a slot 46 formed in the lever 37. That end of the lever 37 opposite the connecting bayonet slot and pin therefore is supported on the frame via the housing 4 by the link 41 and the projection 44. The slot 46 in the lever 37 has an extension 47 in the flange 40. The extension is of such size as to enable the projection 44 to pass through the slot when necessary.

The operation of the embodiment shown in FIGS. 9-12 is very similar to that of previously described embodiment. However, there are some differences as will be explained.

To disconnect the lever arm 37 of the strut 36 from the connecting projection 44 when the strut supports the damper in its retracted position, that end of the lever opposite the bayonet slot and pin connection is moved manually in such direction as to enable the projection 44 to pass out of the opening 43 in the link 41, whereupon the strut may swing downwardly from the position shown in FIG. 10 to the position shown in FIG. 11, thereby disengaging the strut from the damper and enabling the latter to move to its extended, air blocking position.

When it is desired to restore the strut to its damper engaging position following testing of the apparatus, the damper manually may be returned to its retracted position and the strut returned manually to a position in which the projection 44 may enter the opening 43 and be retained therein.

The simplicity of the construction of the strut assembly is such as to make it possible to move the strut between its damper supporting and damper disengaged positions without having to view the parts, thereby avoiding the awkwardness and difficulty in disassembling and reassembling the component parts of the prior art constructions.

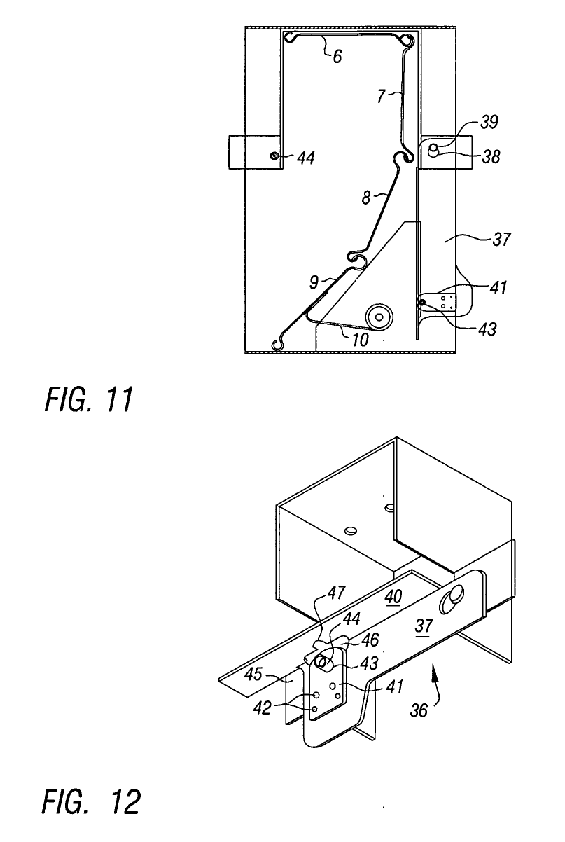

When the ambient temperature rises to a predetermined elevated level, the eutectic material which is interposed between and binds the link 41 to the lever 37 will liquefy. When the eutectic substance liquefies, the strut 36 is free to rock downwardly about the axis of the pin 39 from the position shown in FIG. 12 and such downward movement is unimpeded inasmuch as the projection 44 may pass freely through the slot extension 47. In this event the link 41 will remain suspended from the projection 44 whereas the lever 37 of the strut 36 will assume the position shown in FIG. 13 in which the lever is disengaged from the damper.

When it is desired to test the operability of the damper without liquefying the eutectic material, that end of the lever adjacent the projection 44 may simply be moved in a direction to withdraw the projection 44 from the opening 43, whereupon the strut may be swung to the damper disengaged position. The damper then is free to move to its extended, air blocking position.

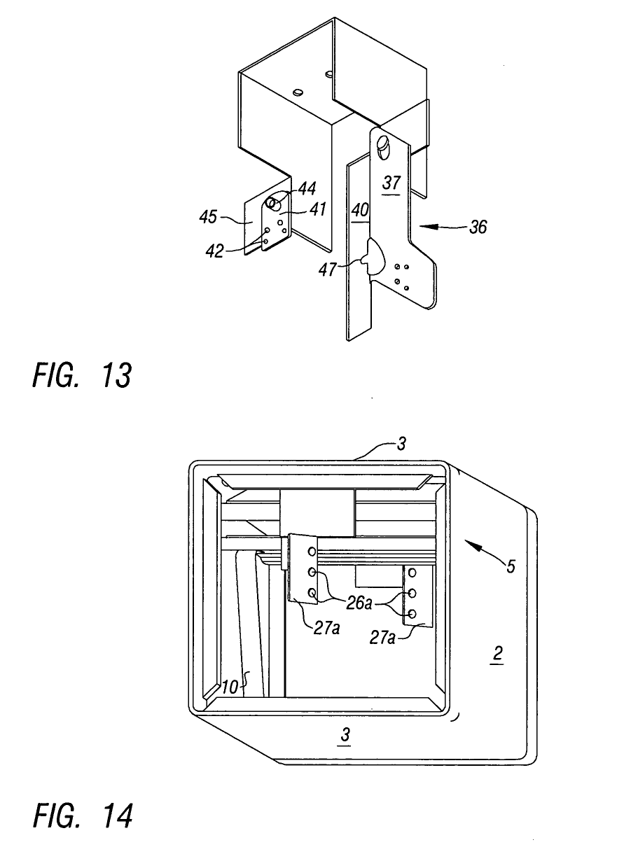

FIG. 14 illustrates a modified frame construction wherein the only differences from that shown in FIG. 1 are that the frame illustrated in FIG. 14 has enlarged mounting tabs 27a on each of which a plurality of vertically spaced connecting pins 26a is mounted. This arrangement enables the level of the damper 5 in its retracted position to be varied.

This disclosure is representative of presently preferred embodiments of the invention, but is intended to be illustrative rather than definitive thereof. The invention is defined in the claims.

I claim:

1. In a fire damper assembly having a frame within which a damper is mounted for movement from a retracted, air passing position to an extended, air blocking position, and in which said damper is biased to move from said retracted position to said extended position, said damper normally being engaged and supported in said retracted position by a strut composed of joined, separable components which separate automatically in response to an increase in ambient temperature to a predetermined level thereby enabling said strut to collapse and said damper to move to said extended position, the improvement comprising first and second connecting means connecting opposite ends of said strut to said frame, at least one of said connecting means enabling said strut to pivot about an axis, the other of said connecting means being manually disconnectable, disconnection of said other connecting means while said components of said strut are joined enabling said strut to swing about said axis to a position in which said damper is movable to said extended position, said damper being manually returnable from said extended position to said retracted position, and said strut being manually pivotable about said axis to said damper engaging and supporting position for re-connection to said frame.

2. The assembly according to claim 1 wherein said opposite ends of said strut are connected by said connecting means for pivotal movement of either end of said strut from said damper engaging and supporting position to a position in which said strut is disengaged from said damper.

3. The assembly according to claim 1 including temperature sensitive fusible means coupling the separable components of said strut to one another.

4. The assembly according to claim 3 wherein portions of adjacent ones of said components overlap one another and wherein said temperature sensitive fusible means comprises a eutectic substance interposed between the overlapping portions of said components.

5. The assembly according to claim 1 wherein said strut comprises a pair of links having overlapping ends joined to one another by said eutectic substance.

6. The assembly according to claim 5 wherein the links of said pair of links are spaced from one another by a gap, and including a pair of connectors spanning said gap, said connectors having portions thereof overlapping one another and being joined by said eutectic substance, said connectors having opposite ends respectively joined to said links.

7. The assembly according to claim 1 wherein said strut comprises a lever one end of which is pivoted to said frame by one of said connecting means, said lever having at its opposite end a connecting link extending from said lever to the other of said connecting means, said connector being joined to said lever by said eutectic material.

8. The assembly according to claim 7 wherein said connecting means includes a projection carried by said frame and removably extending through an opening in said lever.

9. The assembly according to claim 8 wherein said lever has a slot through which said projection may pass when said connecting link separates from said lever in response to liquefication of said eutectic material.

10. The assembly according to claim 1 including spring means biasing said damper toward said extended position.

11. The assembly according to claim 1 wherein at least one of said first and second connecting means comprises a bayonet slot and pin.

12. A fire damper assembly comprising a frame; a damper mounted on said frame for movements between a retracted air-passing position and an extended air-blocking position; means biasing said damper toward said extended position; a support member having opposite ends and being formed of separable components joined by a eutectic substance which liquefies and releases said components in response to an increase in ambient temperature to a predetermined level; and mounting means for mounting said support member in a damper engaging position to support said damper in said retracted position when said ambient temperature is at a level lower than that of said predetermined level, said support member when supporting said damper underlying and engaging said damper, said mounting means comprising a pivotal connection of one end of said support member to said frame and a releaseable connection of the opposite end of said support member to said frame, the release of said releasable connection enabling said support member to rock about said pivotal connection to a position in which said support member is disengaged from said damper thereby enabling said damper to move from said retracted position to said extended position, said damper being returnable to said retracted position and said support member being manually rotatable about said axis to said damper engaging position, said support member being manually reconnectable to said releaseable connecting means to maintain said damper in said retracted position.

13. The assembly according to claim 12 wherein said releaseable connecting means comprises a bayonet slot and pin.

14. The assembly according to claim 12 wherein said releaseable means comprises a pin and a slot through which said pin removably extends.

15. The assembly according to claim 12 wherein said support member components include a pair of links having overlapping portions, said eutectic substance being interposed between said overlapping portions.

16. The assembly according to claim 12 wherein said support member components include a lever having at one end thereof a link forming part of said releasable connecting means, said link and said lever constituting the component joined by said eutectic substance.

17. The assembly according to claim 12 wherein said lever has a slot through which said projection may pass when said connecting link separates from said lever in response to liquefication of said eutectic material.

18. The assembly according to claim 12 wherein said biasing means comprises a spring.
